(19) United States
(12) Patent Application Publication
(10) Pub. No.: US 2011/0209215 A1
(43) Pub. Date: Aug. 25, 2011

(54) Intelligent Network Security Resource Deployment System

(76) Inventor: Hazem Kabbara, Boylston, MA (US)

(21) Appl. No.: 12/710,223

(22) Filed: Feb. 22, 2010

(51) Int. Cl. G06F 11/00

(52) U.S. Cl. 726/22

(57) ABSTRACT

An electronic communication network includes a connectivity subsystem and security scanning resources. The connectivity subsystem checks the present trust level of the source of received traffic to determine if security scanning resources are to be used and how to use the security scanning resources.

### FIELD

Embodiments of the present invention relate in general to the field of network security and, more specifically, to intrusion prevention systems and the deployment of traffic scanning resources.

### BACKGROUND

Electronic communication networks based on the Internet Protocol (IP) have become ubiquitous. Although the primary focus of the information technology (IT) industry over the last two decades has been to achieve “anytime, anywhere” IP network connectivity, that problem has, to a large extent, been solved. Individuals can now use a wide variety of devices connected to a combination of public and private networks to communicate with each other and use applications within and between private enterprises, government agencies, public spaces (such as coffee shops and airports), and even private residences. A corporate executive can now reliably send an email message wirelessly using a handheld device at a restaurant to a schoolteacher using a desktop computer connected to the Internet by a wired telephone line halfway around the world.

In other words, virtually any IP-enabled device today can communicate with any other IP-enabled device at any time. Advances in the resiliency, reliability, and speed of IP connections have been made possible by improvements to the traditional routers and switches that form the “IP connectivity” of IP networks. Such “IP connectivity” networks have propelled business productivity enormously the world over.

Concurrently, the sophistication of internal and external network attacks in the form of viruses, Trojan horses, worms and malware of all sorts has increased dramatically. Just as dramatic is the accelerated increase of network speeds and a corresponding drop in their cost, thereby driving their rapid adoption. These factors and others have necessitated the development of innovative and more advanced network security mechanisms. Enterprise executives understand this reality. From a technical perspective, CIOs know that the current connectivity network cannot resolve security and application performance issues. In turn, from a financial perspective, CFOs are concerned that it will be too expensive to solve these problems by performing full IPS coverage on each network link. Finally, from an overall business perspective, CEOs cannot tolerate network security downtime risk, and are demanding predictable, stable application performance.

Consider some of the problems of conventional connectivity networks in more detail. One solution to this problem has been to use firewalls to establish a network “perimeter” defining which users and devices are “inside”—and therefore authorized to access the network—and which users and devices are “outside”—and therefore prohibited from accessing the network. The concept of a clear network perimeter made sense when all users accessed the network from fixed devices (such as desktop computers) that were physically located within and wired to the network. Now, however, users access the network from a variety of devices—including laptops, cell phones, and PDAs—using both wired and wireless connections, and from a variety of locations inside and outside the physical plant of the enterprise. As a result, the perimeter has blurred, thereby limiting the utility of firewalls and other systems which are premised on a clear inside-outside distinction.

The typical cost of a successful attack is higher today than in the past because of the increased value of information stored on modern networks. The use of networks to connect a larger number and wider variety of devices is both causing problems for traditional access control mechanisms and leading to the use of the network to store increasingly high-value information. Although one way to protect information stored on the network would be to use intrusion prevention systems (IPSs) to perform deep packet inspection on each link, or along the entire network perimeter, the cost of doing so at the high speeds required by modern networks is prohibitively expensive. Therefore, there is a need to provide a low-cost mechanism for preventing high-cost network security breaches.

### SUMMARY

Embodiments of the present invention provide a low-cost mechanism for preventing high-cost network security breaches. In one embodiment of the present invention, a meta-policy is created and utilized to determine the present trust level of traffic associated with a source. The dynamic meta-policy may only associate one or more actions with an input, and thereby differ from a static policy. In particular, the meta-policy may be a series of input-to-action associations, where each association is valid during a particular state of the meta-policy. The meta-policy may also include state transition descriptions that transition the meta-policy from one state to another state.

For example, in one embodiment of the present invention, an electronic communication network includes connectivity devices. A connectivity system, upon receiving network traffic, determines a source of the traffic, sends a present trust level request to a present trust level system, receives a present trust level response, and, based on that response, either forwards the traffic directly or directs the traffic to security traffic inspection resources.

For example, one embodiment of the present invention is directed to a method and/or system comprising: (A) at a network traffic receiving subsystem: (A)(1) receiving first network traffic; (A)(2) identifying a first source of the first network traffic; (A)(3) requesting a first present trust level of the first source from a present trust subsystem; (A)(4) receiving the first present trust level of the first source from the present trust subsystem; (A)(5) determining whether to provide the first network traffic to an intrusion prevention subsystem based on the first present trust level of the first source; and (A)(6) providing the first network traffic to the intrusion prevention subsystem if it is determined that the first network traffic should be provided to the intrusion prevention subsystem.

Another embodiment of the present invention is directed to a method and/or system comprising: (A) receiving, from a network traffic receiving subsystem, a first request for a first present trust level of a first source of first network traffic; (B) determining the first present trust level of the first source based on an identifier of the first source and a first policy associated with the first source; and (C) sending, to the network traffic receiving subsystem, a response specifying the first present trust level of the first network source.

Yet another embodiment of the present invention is directed to a method and/or system comprising: (A) receiving, from a network traffic receiving subsystem, a first request for a first present trust level of a first source of first network traffic; (B) determining the first present trust level of the first source based on an identifier of the first source and at least one of: other network traffic received from the first source; a location of a network connection of the first source; and an application associated with the first source; and (C) sending, to the network traffic receiving subsystem, a response specifying the first present trust level of the first network source.

Other features and advantages of various aspects and embodiments of the present invention will become apparent from the following description and from the claims.

### BRIEF DESCRIPTION OF THE DRAWINGS

FIG. 1 is a diagram of an electronic communication network according to one embodiment of the present invention;

FIG. 2 a diagram of data objects and logic according to one embodiment of the present invention;

FIGS. 3A-3B are diagrams of an electronic communication network and a present network trust engine according to two embodiments of the present invention;

FIG. 4A-4E show a state machine diagram and logic flowcharts according to one embodiment of the present invention;

FIG. 5 is a diagram of a recent history data format according to one embodiment of the present invention; and

FIG. 6 is a diagram of a network data format according to one embodiment of the present invention.

### DETAILED DESCRIPTION

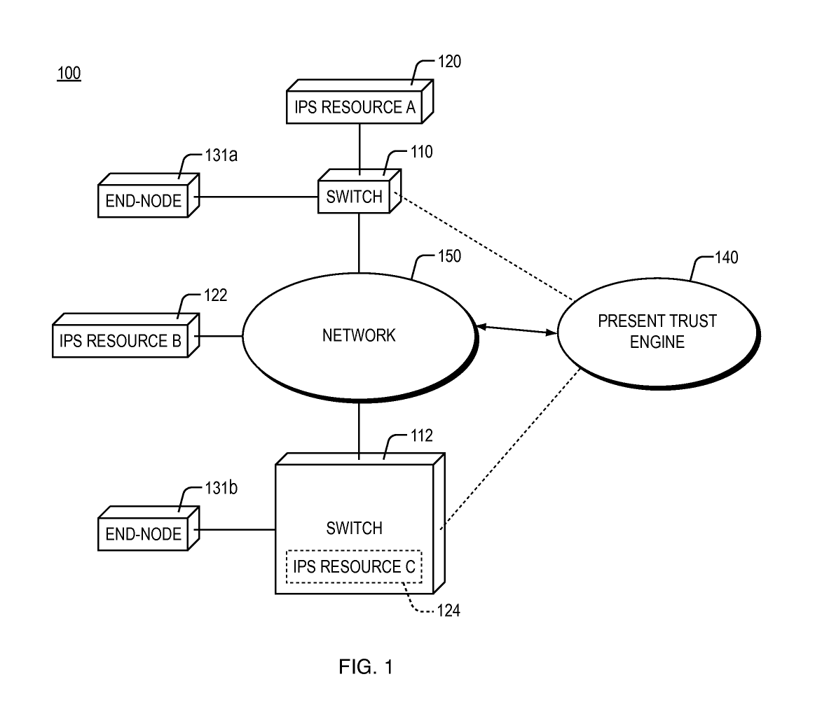

Referring to FIG. 1, a diagram is shown of an electronic communication network 100 according to one embodiment of the present invention. The network 100 includes end nodes 131a and 131b, switches 110 and 112, intrusion prevention system (IPS) Resource A 120, IPS Resource B 122, IPS Resource C 124, and a Present Trust Engine 140 interconnected by one or more networking devices (labeled as Network 150). As used herein, the term “end node” refers to a combination of a particular network source's hardware platform and the applications executing on the source. For example, end node 131a refers to a combination of a first network source's hardware platform and the applications executing on the first source, while end node 131b refers to a combination of a second network source's hardware platform and the applications executing on the second source.

End nodes 131a and 131b send packets that are received by switches 110 and 112. The switches 110 and 112 request a present trust level of the source of the received packet. The “present” trust level of the source refers to a trust level of the source at or around the time at which the packet was received by one of the switches 110 and 112. As a result, the present trust level of the source may change over time. For example, the source may have a first present trust level at a first time and a second present trust level, which may be the same as or differ from the first present trust level, at a second time. When an endnode is running a virtual environment the switch function may be implemented in the endnode network adapter (not shown in FIG. 1). In this case the endnode adapter would send the present trust level request to Present Trust Engine 140 and would receive the response. The network adapter could send the traffic to and an external IPS resource or have network adapter resident IPS resources process the packet.

The Present Trust Engine 140 receives the request, identifies the present trust level of the source, and sends to the switch a response which indicates the identified present trust level of the source. The Present Trust Engine 140 may identify the present trust level of the source by, for example, reading: (1) a data object that contains dynamic meta-policy information (data and logic), and (2) (optionally) other network information. The other network information may, for example, include network traffic history and/or network device capabilities of a specified network location.

The Present Trust Engine 140 responds to the requesting switch with the present trust level of the network source. The Present Trust Engine 140 may also pass traffic redirect instructions back to the requesting switch. The switch uses the response to decide whether to forward the packet without utilizing IPS resources or to redirect the packet to an IPS resource for scanning (i.e., deep packet inspection). If the switch redirects the packet to an IPS resource, the switch may pass security scanning parameters to the IPS resource, in which case the IPS resource may use the security scanning parameters to focus the packet scanning operation. The traffic redirect instructions passed back to the switch, if any, may include, for example, information about which IPS resource to use and information about the endnode's traffic that may be used by the IPS resource to focus its traffic inspection actions. Information about the endnode's traffic may include, for example, information about the applications which transmitted the traffic, the hardware platform of the endnode, and the endnode's security track record.

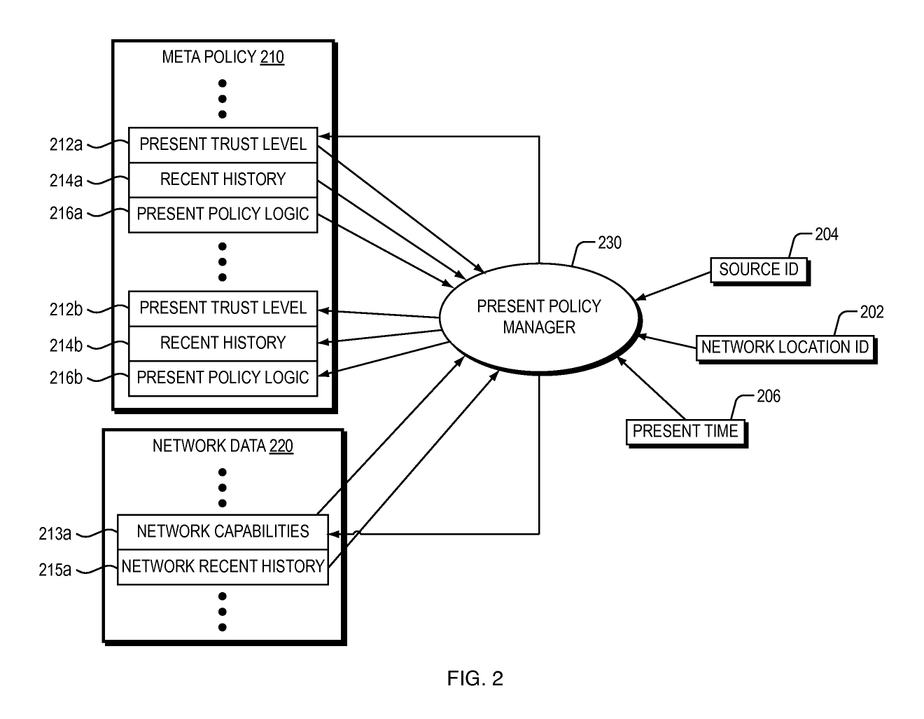

Referring to FIG. 2, a diagram is shown which depicts how a Network Data object 220 and dynamic Meta-Policy data object 210 may be used by a Present Policy Manager 230, within the Present Trust Engine 140, to determine the Present Trust Level of a particular source using a network Source ID 204 and Network Location ID 202 as inputs. The Meta-Policy data object 210 may include data related to a plurality of sources. The network Source ID 204 identifies a particular network source for which a present trust level is sought, and thereby indicates which part(s) of the dynamic Meta-Policy data object 210 is/are relevant to the particular network source.

The Present Policy Manager 230 therefore uses the network Source ID 204 to identify the part(s) of the Meta-Policy data object 210 which is/are relevant to the particular network source. Assume, for example, that the Source ID 204 identifies the part of the Meta-Policy data object 210 containing elements 212a, 214a, and 216a. In this case, the Present Trust Level 212a may represent the most-recently determined present trust level of the particular network source, the Recent History 214a may represent network traffic sent by the particular network source, and the Present Policy Logic 216a may contain logic which may be used to determine a new present trust level of the particular network source.

The Present Policy Manager 230 may read the Present Trust Level 212a, the Recent History 214a, and the Present Policy Logic 216a associated with the particular network source. This data 212a, 214a, and 216a may each have its own time stamp. The Present Policy Manager 230, therefore, may compare the time stamps of the data 212a, 214a, and 216a to the Present Time 206 to determine how recent the data 212a, 214a, and 216a is.

As described in more detail below, the Present Policy Manager 230 may use the Present Policy Logic 216a associated with the particular network source to determine a new present trust level of the particular network source. The Present Policy Manager 230 may then update the dynamic Meta-Policy data object 210 to reflect this new present trust level. Furthermore, the Present Policy Manager 230 may update the dynamic Meta-Policy data object 210 to reflect the new recent history of the particular network source, and to reflect new present policy logic associated with the particular network source. For example, as shown in FIG. 2, the Present Policy Manager 230 may write the new trust level of the particular network source to Present Trust Level 212b, write the recent traffic history of the particular network source to Recent History 214b, and write appropriate logic (which may be the same as or differ from the previous Present Policy Logic 216a) to Present Policy Logic 216b.

In the particular example shown in FIG. 2, the Meta-Policy object 210 contains a log of information about the particular network source, with older information being stored in elements 212a, 214a, and 216a, and with newer information being stored in elements 212b, 214b, and 216b. This is not, however, a requirement of the present invention. As an alternative, for example, newer information (such as that stored in elements 212b, 214b, and 216b) may replace or be combined with older information (such as that stored in elements 212a, 214a, and 216a). As another example, a log may be maintained as illustrated in FIG. 2, but information in the log may be compressed with or without loss.

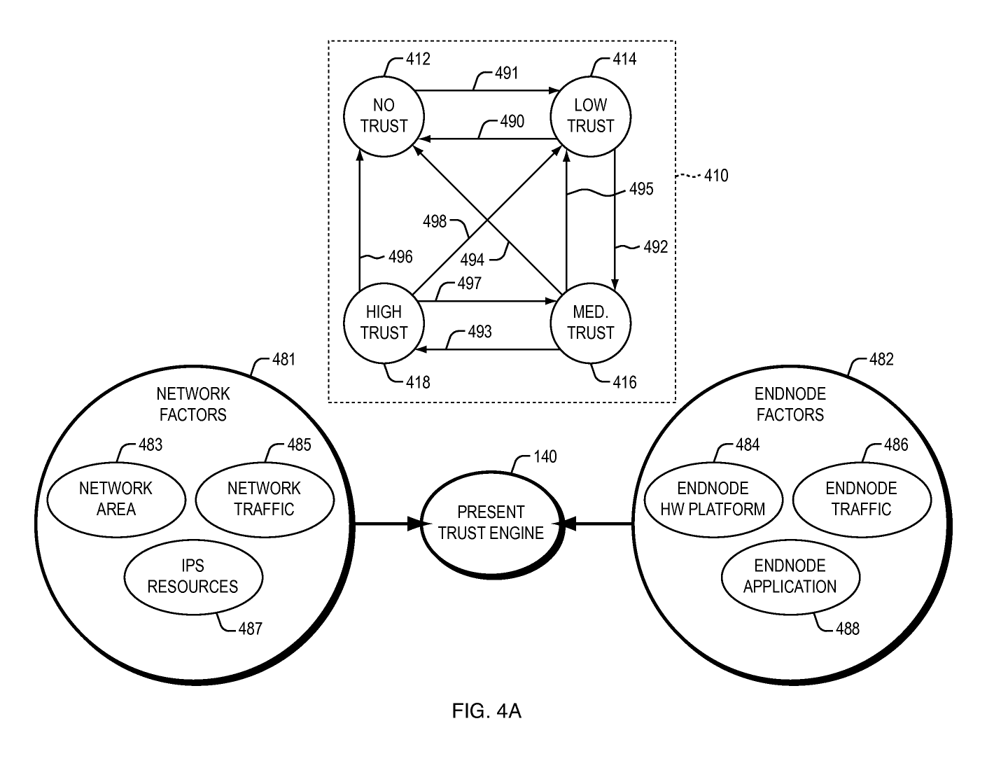

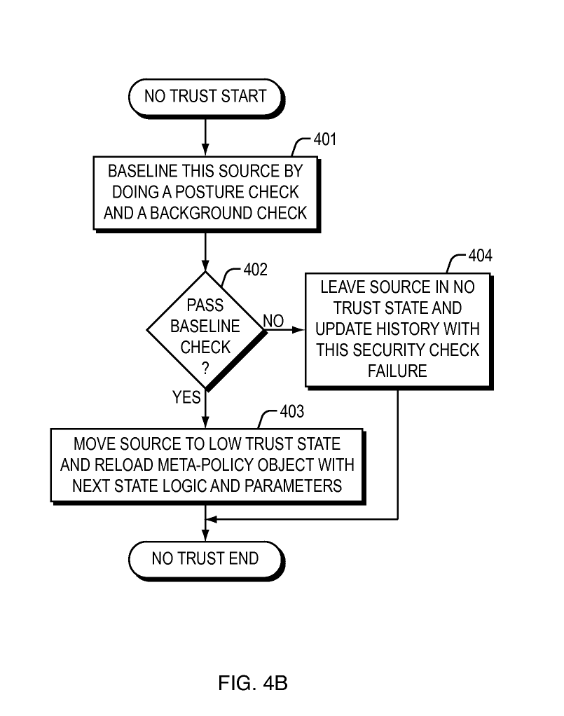

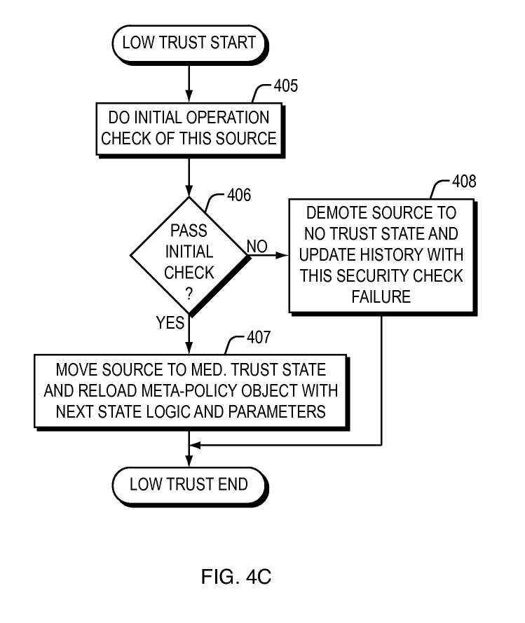

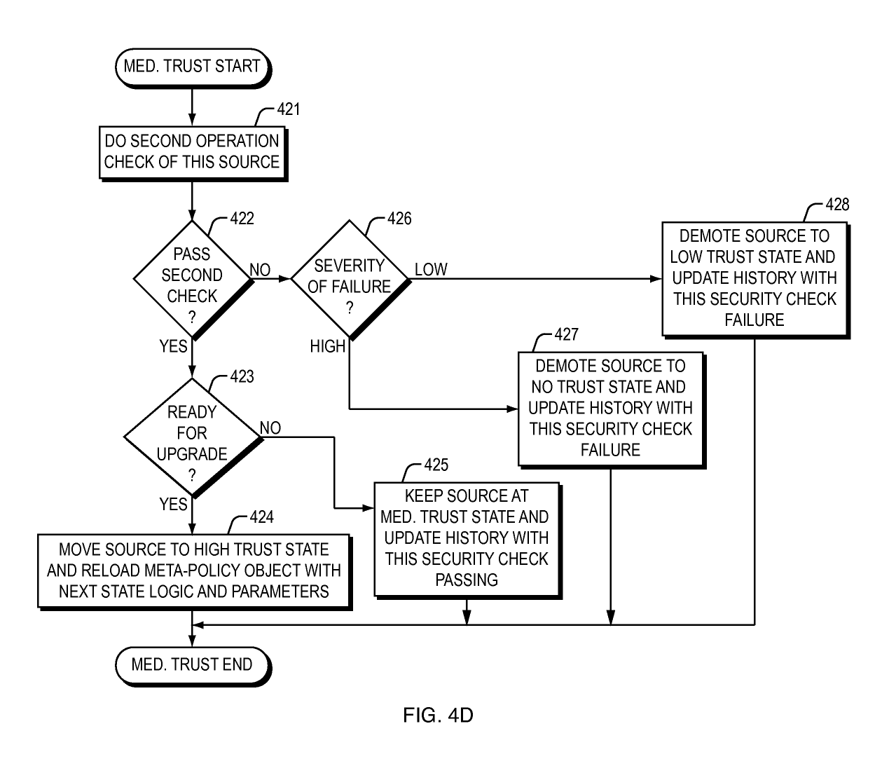

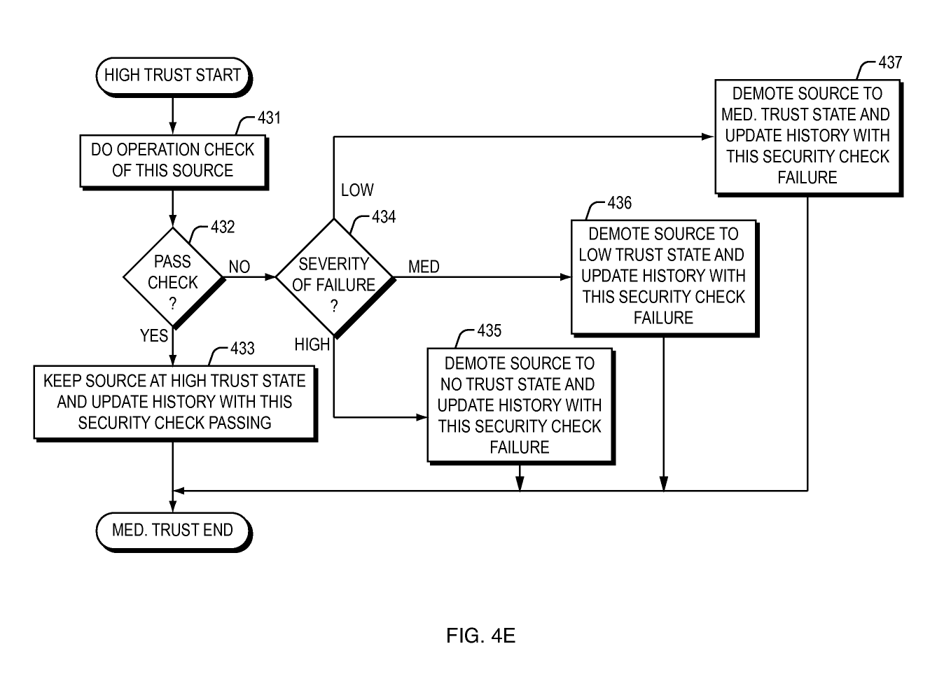

Updating the Meta-Policy data object 210 with new present policy logic makes the Meta-Policy data object 210 a dynamic data object. This enables the present trust level of the network source to change over time, either building (increasing) or losing (decreasing) trust based upon factors such as network or end node history and end node network locations. An example of a trust calculation state machine which may be used to enable such changes in trust level over time is further described below in connection with FIG. 4.

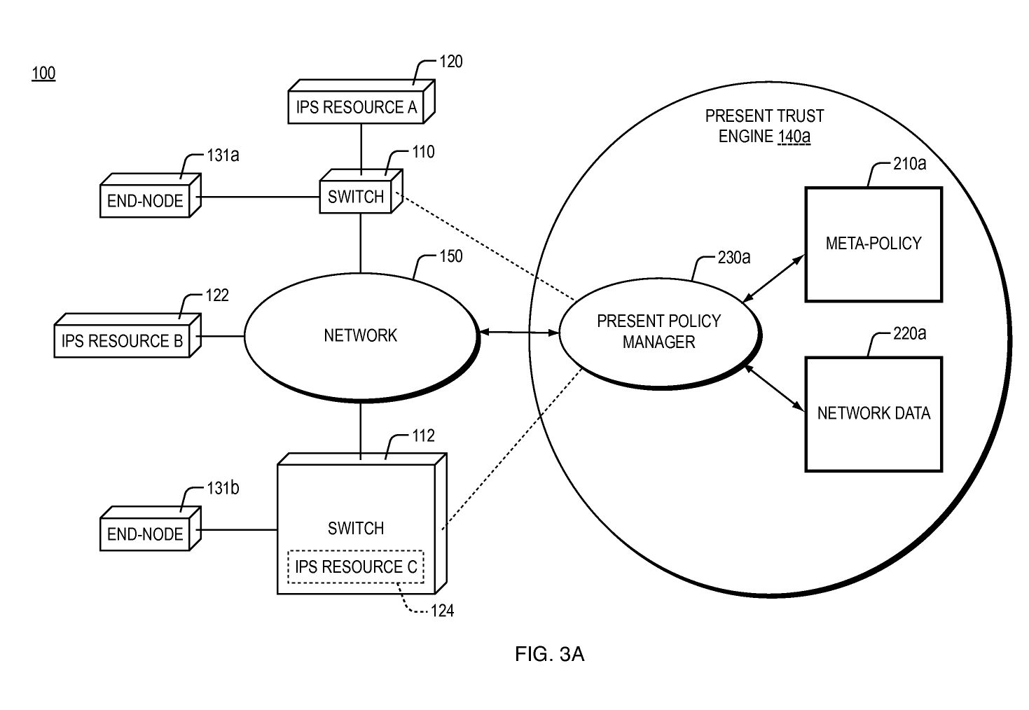

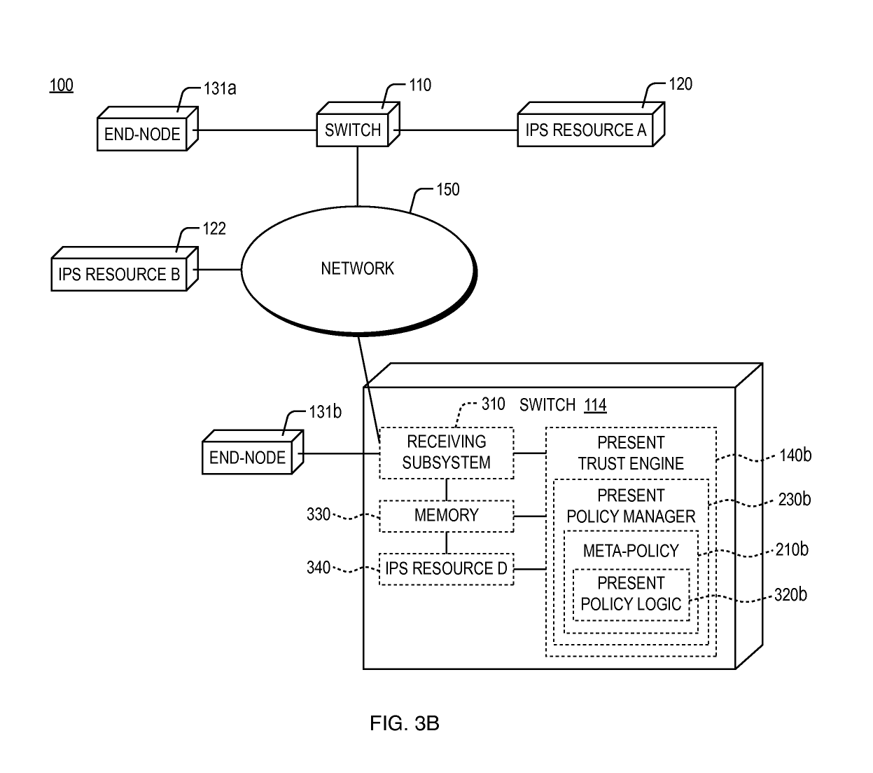

Referring to FIGS. 3A-3B, the internals of two different embodiments of the Present Trust Engine 140 are shown. The Present Policy Manager 230 updates the dynamic Meta-Policy data object 210 and Network Data 220 information to provide the latest historical information and network capabilities. The Present Policy Manager 230 may obtain network traffic historical information by, for example, using its own network traffic historical information-gathering logic, or by reading network traffic historical information from a network service (not shown) that offers this information. The present policy logic stored in the Meta-Policy data object 210 may be executed, for example, by a processor that executes instructions or by logic circuitry that perform a defined function. FIG. 3A shows an implementation of the present invention in which the Present Trust Engine 140a resides on a dedicated platform implemented by a processor. FIG. 3B shows an implementation of the present invention in which the Present Trust Engine 140b resides on a switch 214 on an ASIC or FPGA.

In the embodiment illustrated in FIG. 3A, the request comes from Switch 110 or IPS Resource 120 over the network 150 to the dedicated platform implementing the Present Trust Engine 140a by using a processor-based system. This processor-based system may, for example, be a multiprocessor/multi-core system with hardware support for dedicated functions. The logic in the Meta-Policy data object 210a may include computer program instructions tangibly stored on a computer-readable medium and be executed on one or more processors.

In the embodiment illustrated in FIG. 3B, the request comes from the Receiving Subsystem 310, which may be implemented within the same ASIC (or other single chip), circuit board, chassis system, or otherwise within the same hardware enclosure as the Present Trust Engine 140b. The logic stored in the Meta-Policy data object 210b is executed on one or more logic circuits. Information from the request, and optionally packet data stored in Memory 330, is used by the Present Policy Manager 230b to determine the next trust level, using information stored in the Meta-Policy data object 210b which indicates which logic circuits should be used to determine the next trust level. Furthermore, the Present Trust Engine 140a may pass instructions to the IPS Resource 340, which may access Memory 330 to inspect the traffic. These instructions may inform the IPS Resource 340 of the specifics of the possible threats this traffic may pose. Information about the application and end node hardware platform type may be used by IPS Resource 340 to focus its traffic inspection actions.

Referring to FIG. 4A, a state diagram 410 depicts a progression of Present Policy Logic elements that are loaded in the dynamic Meta-Policy object 210 as a source ID transitions from a “no trust” state to a “high trust” state. The flow charts of FIGS. 4B-4E show the present policy logic elements used at each trust state, including the No Trust state 412 (FIG. 4B), the Low Trust state 414 (FIG. 4C), the Medium trust state 416 (FIG. 4D), and the High Trust state 418 (FIG. 4E). A source may start out in the No Trust state 412 even if the source is well known and trusted, because the source trust may be determined based not only on the user, but also on other factors, such as characteristics of the source (e.g., its hardware platform and applications running on it) and/or the network connection location. Although the following examples show four trust states, this is merely an example and does not constitute a limitation of the present invention. More generally, embodiments of the present invention may use any number of trust states.

Prior art security systems analyze only traffic sent from or to the endnode to determine the potential threat posed by an endnode. Some prior art systems may also do an initial “posture check” of the endnode to assure it has the required software and software versions. In embodiments of the present invention, the Present Trust Engine 140 may both analyze traffic and perform a posture check to determine the potential threat posed by an endnode. More specifically, as shown in FIG. 4A, the Present Trust Engine may take into account both: (1) Endnode Factors 482, such as Endnode Traffic 486, Endnode Hardware Platform 484, and Endnode Application 488; and (2) Network Factors 481, such as Network Traffic 485, Network Area 483 (where the endnode connects to the network), and IPS Resources 487. In lower trust states the Present Trust Engine 140 may rely more heavily on the Endnode Factors 482, while in the higher trust states the Present Trust Engine 140 may rely on a more balanced combination of both Network Factors 481 and Endnode Factors 482 to determine the trust level of an endnode. The Meta-Policy data object 210 (FIG. 2) may include or otherwise be associated with the Endnode Factors 482 (FIG. 4A), while the Network Data 220 (FIG. 2) may include or otherwise be associated with the Network Factors 481 (FIG. 4A).

Referring to FIG. 4B, the No Trust state 412 logic element baselines the source by checking the posture of the endnode to verify that the endnode contains no threat to the network and the attached devices (step 401). The posture check is usually device-specific; the type of software and hardware in the device determine what is verified by the posture check. For example, the posture check may include performing device-specific virus scans, depending on which software (e.g., operating system) is contained in the device. As another example, the posture check may include verifying that the versions of software installed on the device comply with network attachment policy, and determining which type of protection the device needs, and the types of threats the device may pose, depending on which software versions are installed on the device.

If the source passes this baseline check (step 402), then the source is transitioned into the Low Trust state 414 (step 403), represented by transition 491 of the state machine 410 in FIG. 4A. Returning to FIG. 4B, when the source is in the Low Trust State 414, history is maintained on the source's traffic, user, device, and network connection location. Furthermore, the dynamic Meta-Policy object 210 is reloaded with the updated parameters and logic in preparation for the next analysis of the source. If the source does not pass the baseline check (step 402), then the source remains in the No Trust state 412 (step 404).

Referring to FIG. 4C, once in the Low Trust state 414, the source is closely monitored and the network usage history of the source is tracked. After an initial period of time or network usage has been observed and analyzed (step 405), a determination is made whether to upgrade the trust level of the source to the Medium Trust state 414 (step 406). If trust in the source has been built during the initial operation check of step 405, then the source is transitioned to the Medium Trust state 416 (step 407), represented by transition 492 of the state machine 410 in FIG. 4A. Returning to FIG. 4C, if suspicion has been built during the initial operation check of step 405, then the source is transitioned (demoted) to the No Trust state 412 (step 408), represented by transition 490 of the state machine 410 in FIG. 4A.

Referring to FIG. 4D, once the source is in the Medium Trust state 416, the source is monitored and the source's network usage history is tracked. After a policy-based period of time or network usage has been observed and analyzed (step 421), a determination is made if the source has passed a second monitoring period check (step 422). In the second monitoring period, the Present Trust Engine 140 uses both Network Factors 481 and Endnode Factors 482 to determine the trust level of an endnode. If the source passed the second monitoring period check, then a determination is made if trust has been built to merit promotion of the source to the High Trust state 418 (step 423). There may be a minimum time of traffic limit required to establish enough history to promote the trust level. If the trust has been built by examining factors such as one or more of network traffic, type of device used to connect to the network, where the device is connecting to the network, and possible other network activities not yet directly involving this source, then the source is transitioned to the High Trust state 418 (step 424), represented by transition 493 of the state machine 410 in FIG. 4A.

If, however, suspicion has been built by observing the traffic from this source, and/or other Endnode Factors 482 during the second monitoring check of step 421, then the source is transitioned (demoted) to the No Trust state 412 (step 408). The Endnode Factors 482 may include, for example, suspicious traffic sent by the source, a change of the source's network connection location, a change of applications running on the source, or other factor associated with the source. If trust has not been built to merit promotion to the High Trust state 418, then the source is kept at the Medium Trust state 416 (step 425) to again be monitored for a policy-specified period of time. Some sources may not be allowed to enter the High Trust state 418 due to variety of factors such as one or more of the following: a lack of any activity (even if no suspicious activity has been observed); connection of the source to the network at a location deemed risky; and execution of a high-risk application on the source.

If the source does not pass the second monitoring period check of step 422, then a determination is made about the severity of the failure to pass the second monitoring period check (step 426). If the failure was severe enough (e.g., if the severity exceeds some predetermined threshold value) then the source is demoted to No Trust state 412 (step 427), represented by transition 494 of the state machine 410 in FIG. 4A; otherwise the source is demoted to Low Trust state 414 (step 428), represented by transition 495 of the state machine 410 in FIG. 4A.

Referring to FIG. 4E, once in the High Trust state 418 the source is lightly monitored, but Present Policy Manager 230 continues to analyze the Network Traffic 485, Network Area 483 where the endnode is connected to the network, possibly the Endnode Application 488, and the Endnode HW Platform 484 used by the endnode device, or other network activities that may increase the risk of this endnode getting infected or otherwise induced to present a threat to the network. After a policy-based period of time or network usage (step 431), a determination is made if the source should stay in the High Trust state 418 (step 432). If it is determined that the source should stay in the High Trust state 418, then the source's network traffic history information is updated (step 433).

If it is determined that the source should not stay in the High Trust state 418, then the severity of the concern is measured. If the severity is high (e.g., exceeds some predetermined threshold value), such as if traffic from the source is suspicious, or if a location change of the source indicates that another source is masquerading as this source, then the source is demoted to the No Trust state 412 (step 435), represented by transition 496 of the state machine 410 in FIG. 4A. Returning to FIG. 4E, if the severity is medium, such as if evidence indicates that a user of the source is roaming from a Wi-Fi wireless connection to a cell based wireless connection (as indicated, for example, by a change in the source's network connection and/or application), then the source is demoted to the Low Trust state 414 (step 436), represented by transition 498 of the state machine 410 in FIG. 4A. Returning to FIG. 4E, if the severity is low, such as if a user of the source is using a new application that is not recorded in the source's network recent history, then the source is demoted to the Medium Trust state 416 (step 437), represented by transition 497 of the state machine 410 in FIG. 4A.

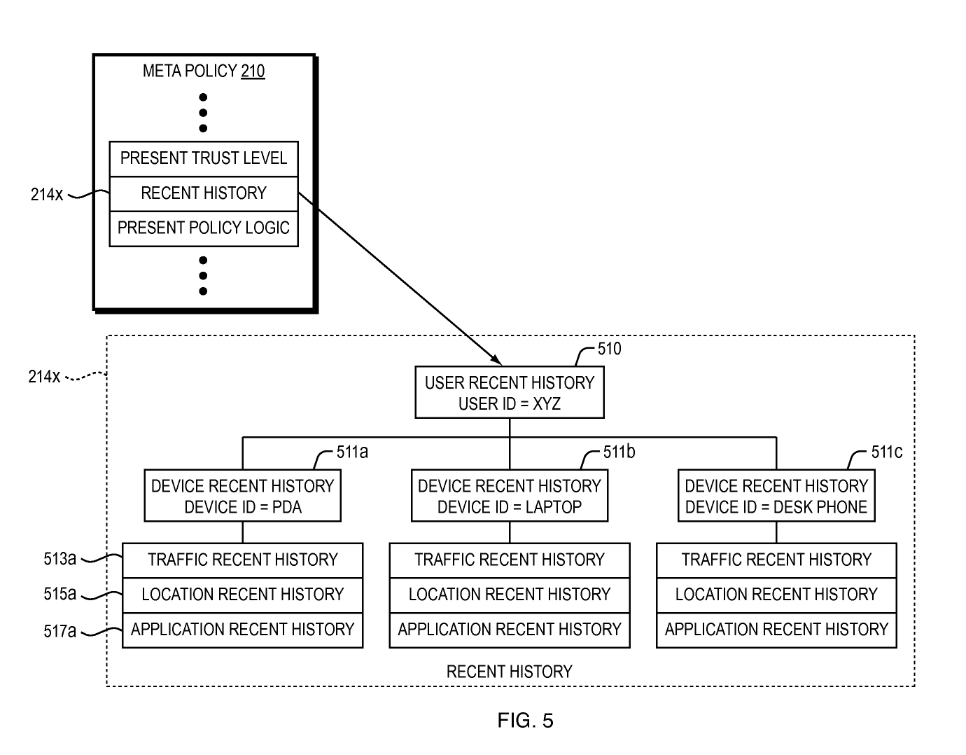

Referring to FIG. 5, the structure of the information used to track the Recent History 214x of a network source is shown according to one embodiment of the present invention. A network source is associated with a User identifier 510. The user may be associated with a multiple network connection devices, such as Device ID=PDA 511a, Device ID=Laptop 511b, Device ID=DeskPhone 511c. The Traffic Recent History 513a, Location Recent History 515a, and Application Recent History 517a are all tracked for each network connection device to be used in the Trust analysis operation.

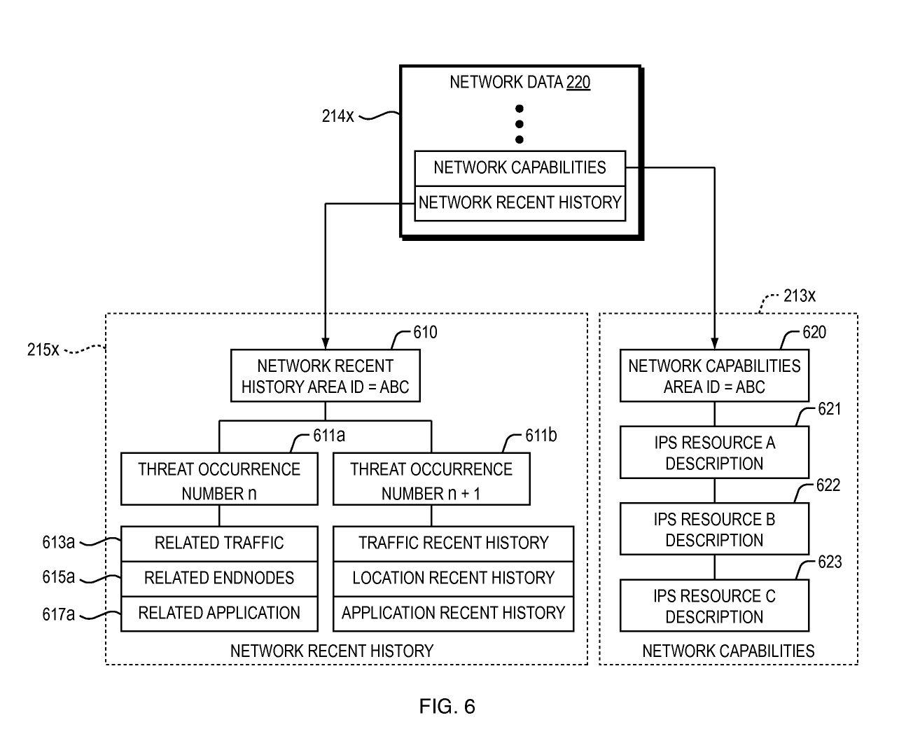

Referring to FIG. 6, the structure of the information used to track the Network Recent History 215x of an area of the network is shown according to one embodiment of the present invention. A network may be divided up into areas. Each of the defined network areas is associated with its own Network Location Identifier 202. The areas may overlap, and are defined to alert the Present Trust Engine 140 of the presence of a potential threat to other endnodes in the network that are connected in the defined network area. This allows the Present Trust Engine 140 to check high trust endnodes that may be running on similar hardware platforms or applications that would be susceptible to threats identified in that network area. For each Network Location ID there is a Network recent History 215x saved to be used by the Present Trust Engine 140.

Also for each network area the capabilities of the IPS resources are saved in Network Capabilities 213x. Each IPS resource has a description stored. This description may contain, for example: hardware capabilities that indicate the performance to the IPS packet scanning; software capabilities that indicate the performance and types of scanning of the IPS resource; the current assigned load; and queue depths. The Network Capabilities 213x is used by the Present Trust Engine 140 to help direct the switch to the IPS resource that will provide the best performance for that endnode at that point in time.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. A method comprising:
(A) at a network traffic receiving subsystem:
(A)(1) receiving first network traffic;
(A)(2) identifying a first source of the first network traffic;
(A)(3) requesting a first present trust level of the first source from a present trust subsystem;
(A)(4) receiving the first present trust level of the first source from the present trust subsystem;
(A)(5) determining whether to provide the first network traffic to an intrusion prevention subsystem based on the first present trust level of the first source; and
(A)(6) providing the first network traffic to the intrusion prevention subsystem if it is determined that the first network traffic should be provided to the intrusion prevention subsystem.

2. The method of claim 1, wherein the network traffic receiving subsystem and the present trust subsystem are implemented in one subsystem.

3. The method of claim 1, wherein the network traffic receiving subsystem and the present trust subsystem are implemented in a plurality of subsystems.

4. The method of claim 1, wherein (A) further comprises:
(A)(7) receiving second network traffic;
(A)(8) identifying a second source of the second network traffic, wherein the second source is the same as the first source;
(A)(9) requesting a second present trust level of the second source from the present trust subsystem;
(A)(10) receiving the second present trust level of the second source from the present trust subsystem, wherein the second present trust level differs from the first present trust level;
(A)(11) determining whether to provide the second network traffic to the intrusion prevention subsystem based on the second present trust level of the first source; and
(A)(12) providing the second network traffic to the intrusion present subsystem if it is determined that the second network traffic should be provided to the intrusion prevention subsystem.

5. The method of claim 4, wherein (A)(5) comprises determining not to provide the first network traffic to the intrusion prevention subsystem, and wherein (A)(11) comprises determining to provide the second network traffic to the intrusion prevention subsystem.

6. The method of claim 4, wherein (A)(5) comprises determining to provide the first network traffic to the intrusion prevention subsystem, and wherein (A)(11) comprises determining not to provide the second network traffic to the intrusion prevention subsystem.

10. A method comprising:
(A) receiving, from a network traffic receiving subsystem, a first request for a first present trust level of a first source of first network traffic;
(B) determining the first present trust level of the first source based on an identifier of the first source and a first policy associated with the first source; and
(C) sending, to the network traffic receiving subsystem, a response specifying the first present trust level of the first network source.

11. The method of claim 10, wherein (B) comprises determining the first present trust level based on the identifier, the first policy, and data descriptive of other network traffic received from the first source.

12. The method of claim 10, wherein (B) comprises determining the first present trust level based on the identifier, the first policy, and a location of a network connection of the first source.

13. The method of claim 10, wherein (B) comprises determining the first present trust level based on the identifier, the first policy, and information about a device used by the first source to access the network traffic receiving subsystem.

14. The method of claim 13, wherein information about the device comprises a recent history of applications executed on the device.

15. The method of claim 13, wherein (A) comprises receiving the request over a network from a switch.

16. The method of claim 13, wherein (B) comprises determining the first present trust level using computer program instructions tangibly stored on a computer-readable medium and executed by at least one computer processor.

17. The method of claim 13, wherein (A) comprises receiving the request at a present trust engine, wherein the network traffic receiving subsystem and the present trust engine are contained within a single hardware enclosure.

18. The method of claim 17, wherein the network traffic receiving subsystem and the present trust engine are implemented on a single chip.

19. The method of claim 13, wherein (B) comprises determining the first present trust level using at least one logic circuit contained with the single hardware enclosure.

20. The method of claim 13, wherein information about the device comprises network traffic transmitted from or received by the device.

21. The method of claim 13, wherein information about the device comprises a history of network connection locations at which the device connected to the network traffic receiving subsystem.

22. The method of claim 10, wherein (B) comprises reading the first policy from a first policy object associated with the first source, and wherein (B) further comprises writing the first present trust level to the first policy object.

23. The method of claim 10, wherein (B) comprises reading the first policy from a first policy object associated with the first source, and wherein (B) further comprises writing a second policy to the first policy object.

24. The method of claim 23, wherein writing the second policy comprises:
selecting the second policy based on the first present trust level; and
writing the second policy to the first policy object.

25. The method of claim 23, wherein writing the second policy comprises replacing the first policy with the second policy in the first policy object.

26. The method of claim 10:
wherein (B) comprises reading, from the first policy object, data descriptive of other network traffic received from the first source, and determining the first present trust level based on the identifier, the first policy, and the data descriptive of other network traffic; and
wherein (B) further comprises updating the data descriptive of other network traffic based on the first network traffic.

27. The method of claim 10, wherein (B) comprises:
(B)(1) identifying an original present trust level of the first source;
(B)(2) performing a check, specified by the first policy, on the first source;
(B)(3) determining, based on whether the first source passed the check, whether to modify the original present trust level of the first source;
(B)(4) if it is determined that the original present trust level of the first source should be modified, then:
(B)(4)(a) assigning a new present trust level to the first source; and
(B)(4)(b) determining that the first present trust level of the first source is the new present trust level;
(B)(5) if it is not determined that the original present trust level of the first source should be modified, then:
(B)(5)(a) determining that the original present trust level of the first source is the first present trust level of the first source.

28. The method of claim 27, wherein the new present trust level is a more trusted trust level than the original present trust level.

29. The method of claim 27, wherein the new present trust level is a less trusted trust level than the original present trust level.

30. The method of claim 27, wherein (B)(3) comprises:
(B)(3)(a) if it is determined that the first source did not pass the check, then determining whether to modify the original present trust level of the first source based on a reason that the first source did not pass the check.

31. The method of claim 30, wherein (B)(4)(a) comprises:
assigning to the first source a first new present trust level that is less trusted than the original present trust level if the reason indicates a low-severity failure; and
assigning to the first source a second new present trust level that is less trusted than the first new present trust level if the reason indicates a high-severity failure.

32. A method comprising:
(A) receiving, from a network traffic receiving subsystem, a first request for a first present trust level of a first source of first network traffic;
(B) determining the first present trust level of the first source based on an identifier of the first source and at least one of:
other network traffic received from the first source;
a location of a network connection of the first source; and
an application associated with the first source;
(C) sending, to the network traffic receiving subsystem, a response specifying the first present trust level of the first network source.

33. A system comprising:
a network traffic receiving subsystem comprising:
network traffic reception means for receiving first network traffic;
first source identification means for identifying a first source of the first network traffic;
first trust level request means for requesting a first present trust level of the first source from a present trust subsystem;
first trust level reception means for receiving the first present trust level of the first source from the present trust subsystem;
first determination means for determining whether to provide the first network traffic to an intrusion prevention subsystem based on the first present trust level of the first source; and
first traffic provision means for providing the first network traffic to the intrusion prevention subsystem if it is determined that the first network traffic should be provided to the intrusion prevention subsystem.

34. The system of claim 33, further comprising the present trust subsystem.

35. The system of claim 33, wherein the network traffic receiving subsystem further comprises:
second network traffic reception means for receiving second network traffic;
second source identification means for identifying a second source of the second network traffic, wherein the second source is the same as the first source;
second trust level request means for requesting a second present trust level of the second source from the present trust subsystem;
second trust level reception means for receiving the second present trust level of the second source from the present trust subsystem, wherein the second present trust level differs from the first present trust level;
second determination means for determining whether to provide the second network traffic to the intrusion prevention subsystem based on the second present trust level of the first source; and
second traffic provision means for providing the second network traffic to the intrusion present subsystem if it is determined that the second network traffic should be provided to the intrusion prevention subsystem.

36. The system of claim 35, wherein the first determination means comprises means for determining not to provide the first network traffic to the intrusion prevention subsystem, and wherein the second determination means comprises means for determining to provide the second network traffic to the intrusion prevention subsystem.

37. The system of claim 35, wherein the first determination means comprises means for determining to provide the first network traffic to the intrusion prevention subsystem, and wherein the second determination means comprises means for determining not to provide the second network traffic to the intrusion prevention subsystem.

38. A present trust engine comprising:
first network traffic reception means for receiving, from a network traffic receiving subsystem, a first request for a first present trust level of a first source of first network traffic;
a present policy manager to use present policy logic to determine the first present trust level of the first source based on an identifier of the first source and a first policy associated with the first source; and
first response means for sending, to the network traffic receiving subsystem, a response specifying the first present trust level of the first network source.

39. The present trust engine of claim 38, wherein the present policy logic comprises logic to determine the first present trust level based on the identifier, the first policy, and data descriptive of other network traffic received from the first source.

40. The present trust engine of claim 38, wherein the present policy logic comprises logic to determine the first present trust level based on the identifier, the first policy, and a location of a network connection of the first source.

41. The present trust engine of claim 38, wherein the present policy logic comprises logic to determine the first present trust level based on the identifier, the first policy, and information about a device used by the first source to access the network traffic receiving subsystem.

42. The present trust engine of claim 38, wherein information about the device comprises a recent history of applications executed on the device.

43. The present trust engine of claim 38, wherein the means for receiving comprises means for receiving the request over a network from a switch.

44. The present trust engine of claim 38, wherein the present policy logic comprises computer program instructions tangibly stored on a computer-readable medium and executed by at least one computer processor.

45. The present trust engine of claim 38, further comprising the network traffic receiving subsystem, and wherein the network traffic receiving subsystem and the present trust engine are contained within a single hardware enclosure.

46. The present trust engine of claim 45, further comprising the network traffic receiving subsystem, and wherein the network traffic receiving subsystem and the present trust engine are implemented on a single chip.

47. The present trust engine of claim 38, wherein the present policy manager comprises at least one logic circuit contained with the single hardware enclosure.

48. The present trust engine of claim 38, wherein information about the device comprises network traffic transmitted from or received by the device.

49. The present trust engine of claim 38, wherein information about the device comprises a history of network connection locations at which the device connected to the network traffic receiving subsystem.

50. The present trust engine of claim 38, wherein the present policy manager comprises a first policy object, means for reading the first policy from the first policy object associated with the first source, and means for writing the first present trust level to the first policy object.

51. The present trust engine of claim 38, wherein the present policy manager comprises a first policy object, means for reading the first policy from a first policy object associated with the first source, and means for writing a second policy to the first policy object.

52. The present trust engine of claim 51, wherein the means for writing the second policy comprises:
means for selecting the second policy based on the first present trust level; and
means for writing the second policy to the first policy object.

53. The present trust engine of claim 51, wherein the means for writing the second policy comprises means for replacing the first policy with the second policy in the first policy object.

54. The present trust engine of claim 38, wherein the present policy manager comprises:
a first policy object;
means for reading from the first policy object data descriptive of other network traffic received from the first source;
and means for determining the first present trust level based on the identifier, the first policy, and the data descriptive of other network traffic; and
means for updating the data descriptive of other network traffic based on the first network traffic.

55. The present trust engine of claim 38, wherein the present policy logic comprises:
logic to identify an original present trust level of the first source;
logic to perform a check, specified by the first policy, on the first source;
logic to determine, based on whether the first source passed the check, whether to modify the original present trust level of the first source;
logic to assign a new present level trust to the first source and to determine that the first present trust level of the first source is the new present trust level if it is determined that the original present trust level of the first source should be modified; and
logic to determine that the original present trust level of the first source is the first present trust level of the first source if it is not determined that the original present trust level of the first source should be modified.

56. The present trust engine of claim 55, wherein the new present trust level is a more trusted trust level than the original present trust level.

57. The present trust engine of claim 55, wherein the new present trust level is a less trusted trust level than the original present trust level.

58. The present trust engine of claim 55, wherein the logic to determine whether to modify the original present trust level comprises logic to determine whether to modify the original present trust level of the first source based on a reason that the first source did not pass the check if it is determined that the first source did not pass the check.

59. The present trust engine of claim 58, wherein the logic to assign a new present trust level comprises:
logic to assign to the first source a first new present trust level that is less trusted than the original present trust level if the reason indicates a low-severity failure; and
logic to assign to the first source a second new present trust level that is less trusted than the first new present trust level if the reason indicates a high-severity failure.

60. A method comprising:
(A) receiving, from a network traffic receiving subsystem, a first request for a first present trust level of a first source of first network traffic;
(B) determining the first present trust level of the first source based on an identifier of the first source and at least one of:
other network traffic received from the first source;
a location of a network connection of the first source; and
an application associated with the first source;
(C) sending, to the network traffic receiving subsystem, a response specifying the first present trust level of the first network source.

61. A system comprising:
first network traffic reception means for receiving, from a network traffic receiving subsystem, a first request for a first present trust level of a first source of first network traffic;
a present policy manager to use present policy logic to determine the first present trust level of the first source based on an identifier of the first source and at least one of:
other network traffic received from the first source;
a location of a network connection of the first source; and
an application associated with the first source;
first response means for sending, to the network traffic receiving subsystem, a response specifying the first present trust level of the first network source.
